(19) United States
(12) Patent Application Publication
(10) Pub. No.: US 2026/0160401 A1
(43) Pub. Date: Jun. 11, 2026

(54) VEHICLE LAMP ASSEMBLY WITH LIGHT BLADE AND LIGHTING METHOD USING LIGHT BLADE

(71) Applicant: Ford Global Technologies, LLC, Dearborn, MI (US)

(72) Inventors: Linsheng Chen, Novi, MI (US); Arun Kumar, Farmington Hills, MI (US); Michael Bryan VanBelle, Canton, MI (US); Anthony Nicholas Aquilina, Royal Oak, MI (US)

(21) Appl. No.: 18/972,015

(22) Filed: Dec. 6, 2024

(51) Int. Cl. F21S 43/31; F21S 43/14; F21S 43/15; F21W 103/35; F21Y 115/10

(52) U.S. Cl. CPC F21S 43/315; F21S 43/14; F21S 43/15; F21W 2103/35; F21Y 2115/10

(57) ABSTRACT

A vehicle lamp assembly includes a light blade of a vehicle lamp and a light source that emits light into the light blade. The light blade has a reflective surface that reflects some of the light outward to an outboard side of a vehicle to provide a side marker light.

### TECHNICAL FIELD

This disclosure relates generally to a lamp assembly for a vehicle and, more particularly, to a lamp assembly incorporating a light blade that can reflect light.

### BACKGROUND

Vehicles can include various types of lamp assemblies. The lamp assemblies are illuminated when light from a light source moves through a lens. Lamp assemblies can include headlamps, taillamps, side marker lights, etc. Side marker lights can help to identify a vehicle's presence, position, and direction of travel, particularly when the vehicle is viewed from an oblique angle.

### SUMMARY

In some aspects, the techniques described herein relate to a vehicle lamp assembly, including: a light blade of a vehicle lamp; and a light source that emits light into the light blade, the light blade having a reflective surface that reflects some of the light outward to an outboard side of a vehicle to provide a side marker light.

In some aspects, the techniques described herein relate to a vehicle lamp assembly, further including a lens that includes a portion on a side of the vehicle, the light reflected outward from the reflective surface passing through the portion on the side of the vehicle.

In some aspects, the techniques described herein relate to a vehicle lamp assembly, wherein the light source includes a plurality of light emitting diodes.

In some aspects, the techniques described herein relate to a vehicle lamp assembly, wherein the plurality of light emitting diodes are disposed along a vertically extending axis.

In some aspects, the techniques described herein relate to a vehicle lamp assembly, wherein the vehicle lamp is a taillamp.

In some aspects, the techniques described herein relate to a vehicle lamp assembly, wherein some of the light passes through the light blade without reflecting off of the reflective surface to provide a stop light for the vehicle.

In some aspects, the techniques described herein relate to a vehicle lamp assembly, wherein the light blade is clear.

In some aspects, the techniques described herein relate to a vehicle lamp assembly, wherein the light blade is solid.

In some aspects, the techniques described herein relate to a vehicle lamp assembly, wherein the light blade has a side surface, and the light reflected by the reflective surface moves through the side surface when exiting the light blade.

In some aspects, the techniques described herein relate to a vehicle lamp assembly, wherein the light reflected by the reflective surface has an intensity of at least 0.25 candela.

In some aspects, the techniques described herein relate to a vehicle lamp assembly, wherein the light that is emitted from the light blade without being reflected by the reflective surface is emitted to a rear of the vehicle.

In some aspects, the techniques described herein relate to a vehicle lamp assembly, wherein the light emitted to the rear of the vehicle provides a stop light for the vehicle.

In some aspects, the techniques described herein relate to a vehicle lamp assembly, wherein the reflective surface is on an inboard corner of the light blade.

In some aspects, the techniques described herein relate to a vehicle lamp assembly, wherein the reflective surface includes an upper reflective surface and a lower reflective surface spaced a distance from the upper reflective surface.

In some aspects, the techniques described herein relate to a vehicle lighting method, including: emitting light from a light source into a light blade of a vehicle; and reflecting some of the light off of a reflective surface of the light blade to a side of a vehicle to provide a side marker light.

In some aspects, the techniques described herein relate to a vehicle lighting method, wherein some of the light that is not reflected off of the reflective surface is emitted from the light blade rearward of the vehicle to provide a stop light of the vehicle.

In some aspects, the techniques described herein relate to a vehicle lighting method, wherein the light emitted to provide the stop light passes through a portion of a taillamp lens and the light reflected to provide the side marker light passes through another portion of the taillamp lens.

In some aspects, the techniques described herein relate to a vehicle lighting method, wherein the reflecting occurs within the light blade.

In some aspects, the techniques described herein relate to a vehicle lighting method, wherein the reflective surface includes an upper reflective surface and a lower reflective surface spaced a distance from the upper reflective surface.

In some aspects, the techniques described herein relate to a vehicle lighting method, wherein the reflective surface is on an inboard corner of the light blade.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a vehicle incorporating a lamp assembly according to an exemplary aspect of the present disclosure.

FIG. 2 illustrates the perspective view of FIG. 1 with a lens of the lamp assembly removed to show a light blade and a light source of the lamp assembly.

FIG. 3 illustrates an expanded perspective view of the light blade and the light source of FIG. 2.

FIG. 4 illustrates an end view of the light blade and the light source of FIG. 3.

FIG. 5 illustrates a section view taken at line 5-5 in FIG. 4.

FIG. 6 illustrates a close up side view of the lamp assembly of FIG. 1 showing the lamp assembly providing a side marker light.

### DETAILED DESCRIPTION

This disclosure relates generally to a lamp assembly that incorporates a light blade and, in particular, to reflecting light using the light blade. The reflected light can be used as a side marker light so that a separate light source for a side marker light is not required.

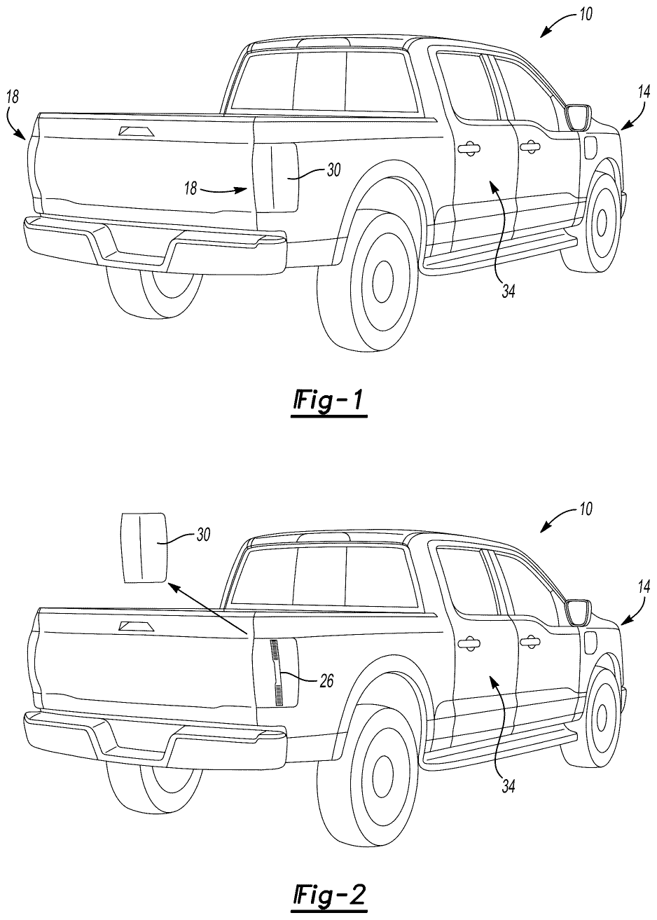

With reference to FIG. 1, a vehicle 10 can include various lamp assemblies including headlamps 14 and taillamps 18. The headlamps 14 can emit light forward from the vehicle 10. The taillamps 18 can emit light rearward from the vehicle 10. While the exemplary embodiments of this disclosure are described in connection with the taillamps 18, the teachings of this disclosure could be applied to other vehicle lamp assemblies, such as the headlamps 14.

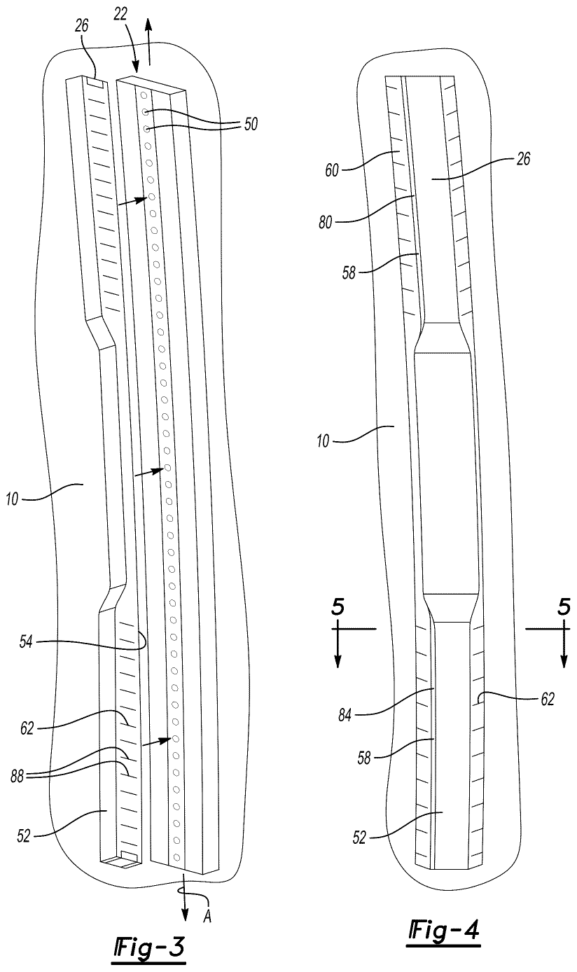

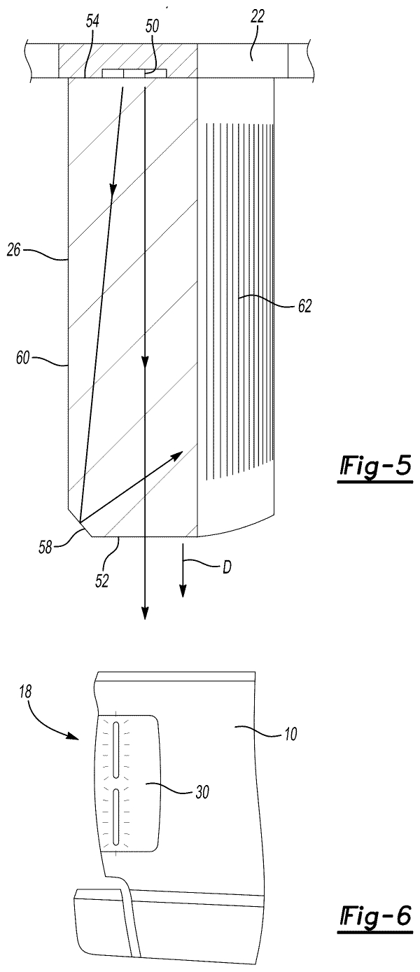

With reference now to FIG. 2-6 and continuing reference to FIG. 1, the example taillamps 18 include a light source 22, a light blade 26, and a lens 30. Details of the taillamp 18 on the passenger side of the vehicle 10 are shown. The taillamp 18 on the driver side is constructed similarly to the taillamp on passenger side.

The taillamps 18 can emit light rearward from the vehicle 10 to provide, for example, a stop light or stop light for the vehicle 10. The light emitted rearward from the taillamps 18, can be viewed from a position behind the vehicle 10. The taillamps 18 can additionally emit light outward to a respective outboard sides 34 of the vehicle 10 to provide a side marker light for the vehicle 10. The side marker light can be viewed from a position alongside the vehicle 10.

The example light source 22 for each of the taillamps 18 is provided by a plurality of Light Emitting Diodes (LEDs) 50. In this example, each of the taillamps 18 includes forty-five LEDs 50 disposed along a vertically extending axis A. The LEDs 50 can be mounted to a printed circuit board.

In this example, the light blade 26 is a clear, polymer-based material, such as polycarbonate material. The light blade 26 is solid. The light blade 26 includes a forward surface 52, an aft surface 54, a reflective surface 58, an inboard side surface 60, and an outboard side surface 62.

The LEDs 50, when activated, emit light through the forward surface 52 into the light blade 26. The light propagates rearward through the light blade 26 in a direction D.

The direction D is normal to the aft surface 54 in this example. The reflective surface 58 is disposed at an angle to the aft surface 54 and to the direction D.

From the light blade 26, a majority of the light passes through the aft surface 54 to provide the stop light for the vehicle 10. Some of the light, however, is redirected by the reflective surface 58 outboard to the respective outboard side 34 of the vehicle 10 to provide the side marker light. The example reflective surface 58 is not coated. The example reflective surface 58 redirects the light outboard due to total internal reflection. In this example, the total internal reflection occurs as the reflective surface 58 is positioned so that the incident angle of light meeting the reflective surface is greater than 39 degrees.

The reflective surface 58 can be sized and positioned to redirect enough light to fulfill a side marker function while still permitting light to pass through the aft surface 54 to fulfill the stop light function.

The reflective surface 58 can be designed by assessing where light will strike at various positions on a hypothetical reflective surface. The points used to guide positions of the reflective surface will be where the light strikes the hypothetical reflective surface and is redirected outward perpendicular to a centerline of the vehicle 10. The reflective surface 58 is then positioned to pass through these points.

The lens 30 of each taillamp 18 wraps around a corner of the vehicle 10 from the rear of the vehicle 10 to the respective outboard side 34. The light that exits the light blade 26 through the aft surface 54 passes through a portion of the lens 30 on the rear of the vehicle 10. The light that is reflected off of the reflective surface 58 and directed to the outboard side 34 of the vehicle 10 passes through a portion of the lens 30 on the outboard side 34.

In some examples, an intensity of the light reflected off of the reflective surface 58 and providing the side marker light can be at least 0.25 candela. The light can be emitted through the portion of the lens 30 on the outboard side 34. A beam angle of the side marker light can extend forty-five degrees forward from the lens 30 toward a front of the vehicle 10 and forty-five degrees rearward of the lens 30 toward a rear of the vehicle 10.

The reflective surface 58 is disposed on an inboard corner of the light blade 26 in this example. The light blade 26 can be molded to include the reflective surface 58.

In this example, the reflective surface 58 provided by the light blade 26 includes an upper reflective surface 80 and a lower reflective surface 84 that is spaced a distance from the upper reflective surface 80. When the LEDs 50 are illuminated and light is reflected off the upper reflective surface 80 and the lower reflective surface 84, the side marker light can include two separately illuminated areas.

Texturing surfaces of the light blade 26, the lens 30, or both can facilitate evenly spreading light. In an embodiment, the texturing can be molded-in. In this example, the outboard side surface 62 of the light blade 26 includes a plurality of molded-in stripes 88.

Features of the disclosed examples include incorporating a light blade into a lamp assembly to reflect light from a light source to provide a side marker light. Thus, a light source devoted solely to illuminating the side marker light may not be required. The same light source can be relied on to illuminate both a stop light and the side marker light.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

1. A vehicle lamp assembly, comprising:
a light blade of a vehicle lamp; and
a light source that emits light into the light blade, the light blade having a reflective surface that reflects some of the light outward to an outboard side of a vehicle to provide a side marker light.

2. The vehicle lamp assembly of claim 1, further comprising a lens that includes a side portion on a side of the vehicle, the light reflected outward from the reflective surface passing through the side portion on the side of the vehicle, the side portion overlapping, in a longitudinal axis of the vehicle, the light blade.

3. The vehicle lamp assembly of claim 1, wherein the light source comprises a plurality of light emitting diodes.

4. The vehicle lamp assembly of claim 3, wherein the plurality of light emitting diodes are disposed along a vertically extending axis.

5. The vehicle lamp assembly of claim 1, wherein the vehicle lamp is a taillamp.

6. The vehicle lamp assembly of claim 1, wherein some of the light passes through the light blade without reflecting off of the reflective surface to provide a stop light for the vehicle.

7. (canceled)

8. The vehicle lamp assembly of claim 1, wherein the light blade is solid.

9. The vehicle lamp assembly of claim 1, wherein the light blade has a side surface, and the light reflected by the reflective surface moves through the side surface facing the outboard side of the vehicle when exiting the light blade.

11. The vehicle lamp assembly of claim 1, wherein the light that is emitted from the light blade without being reflected by the reflective surface is emitted to a rear of the vehicle.

12. (canceled)

13. The vehicle lamp assembly of claim 1, wherein the reflective surface is on an inboard corner of the light blade and wherein the reflective surface at least partially reflects some of the light back toward the light source.

14. The vehicle lamp assembly of claim 1, wherein the reflective surface comprises an upper reflective surface and a lower reflective surface spaced a distance from the upper reflective surface.

15. A vehicle lighting method, comprising:
emitting light from a light source into a light blade of a vehicle; and
reflecting some of the light off of a reflective surface of the light blade to a side of a vehicle to provide a side marker light.

16. The vehicle lighting method of claim 15, wherein some of the light that is not reflected off of the reflective surface is emitted from the light blade rearward of the vehicle to provide a stop light of the vehicle.

17. The vehicle lighting method of claim 16, wherein the light emitted to provide the stop light passes through a first portion of a taillamp lens and the light reflected to provide the side marker light passes through a second portion of the taillamp lens, wherein the first portion faces rearward, wherein the second portion faces outboard.

18. The vehicle lighting method of claim 15, wherein the reflecting occurs within the light blade.

19. (canceled)

20. The vehicle lighting method of claim 15, wherein the reflective surface is on an inboard corner of the light blade.

21. The vehicle lamp assembly of claim 1, wherein the light source emits light into the light blade in a first direction, wherein the reflective surface that reflects some of the light reflects the light at least partially in a second direction that is opposite the first direction and to the outboard side of the vehicle.

22. The vehicle lighting method of claim 15, wherein the reflecting comprises reflecting some of the light off of the reflective surface back toward the light source.

23. A vehicle lamp assembly, comprising:
a light blade of a vehicle lamp having an aft surface, a forward surface, an inboard side surface, an outboard side surface, and a reflective surface; and
a light source configured to emit light into the light blade in a first direction, the reflective surface angled relative to the first direction and configured to reflect at least a portion of the light in a second direction through the outboard side surface, the second direction having a component opposite the first direction and a component laterally outward toward an outboard side of a vehicle.

24. The vehicle lamp assembly of claim 23, wherein the light source is configured to emit light into the light blade through the aft surface, the first direction is rearward in the vehicle.
